(19) United States
(12) Patent Application Publication
(10) Pub. No.: US 2025/0026220 A1
(43) Pub. Date: Jan. 23, 2025

(54) SYSTEMS AND METHODS FOR CONTROLLING ELECTRIC VEHICLE CHARGING APPARATUSES

(71) Applicant: GM GLOBAL TECHNOLOGY OPERATIONS LLC, Detroit, MI (US)

(72) Inventors: Derek HUNTER, Ann Arbor, MI (US); Sheryl BOLLER, Trenton, MI (US); Mary GILLIAM, Farmington Hills, MI (US); Maryssa Lynn WEIR, West Bloomfield, MI (US); Frank VU, Warren, MI (US); Xiang ZHAO, Novi, MI (US); Dalong GAO, Rochester, MI (US)

(21) Appl. No.: 18/354,806

(22) Filed: Jul. 19, 2023

(51) Int. Cl. B60L 53/37; B60L 53/16; B60L 53/66

(52) U.S. Cl. CPC B60L 53/37; B60L 53/16; B60L 53/66

(57) ABSTRACT

A charging system includes a mobile charging apparatus having a charging plug configured to connect to a charging port of a vehicle for charging a battery in the vehicle, and a control module in communication with the mobile charging apparatus. The control module configured to receive a charging request signal from a vehicle control module of the vehicle or a user device, in response to receiving the charging request signal, determine a location of the charging port of the vehicle, and control the mobile charging apparatus to move adjacent to the charging port of the vehicle based on the determined location of the charging port. Other examples charging systems and methods of controlling mobile charging apparatuses are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for controlling electric vehicle charging apparatuses, and more particularly to controlling movement of electric vehicle charging apparatuses to align charging plugs with charging ports of electric vehicles.

Charging apparatuses are employed for charging batteries in electric vehicles. The charging apparatuses typically include a cable electrically connected to a power source and a plug electrically connected to the cable. The plug may be inserted into a charging port of an electric vehicle. After insertion, the power source provides electric power to the charging port via the cable to charge a battery in the electric vehicle.

### SUMMARY

A charging system includes a mobile charging apparatus having a charging plug configured to connect to a charging port of a vehicle for charging a battery in the vehicle, and a control module in communication with the mobile charging apparatus. The control module configured to receive a charging request signal from a vehicle control module of the vehicle or a user device, in response to receiving the charging request signal, determine a location of the charging port of the vehicle, and control the mobile charging apparatus to move adjacent to the charging port of the vehicle based on the determined location of the charging port.

In other features, the mobile charging apparatus includes a movable arm connected to the charging plug, the movable arm includes at least one actuator, and the control module is configured to control the at least one actuator to align the charging plug with the charging port of the vehicle.

In other features, the movable arm includes a sensor positioned adjacent to the charging plug, the sensor is configured to detect a user input applied to the charging plug when a user moves the charging plug, and the control module is configured to receive a signal from the sensor indicative of the user input and control the at least one actuator to move the charging plug based on the received signal.

In other features, the user input includes at least one of a torque and a force applied to the charging plug.

In other features, the control module is configured to receive vehicle data from the vehicle control module or the user device and determine the location of the charging port of the vehicle based on the vehicle data.

In other features, the charging system further includes at least one sensor in communication with the control module. The at least one sensor is configured to detect the location of the charging port of the vehicle. The control module is configured to receive a signal from the at least one sensor indicative of the detected location and determine the location of the charging port of the vehicle based on the received signal.

In other features, the control module is configured to transmit a confirmation request signal including the determined location of the charging port to the vehicle control module or the user device, thereby prompting a user to confirm the determined location of the charging port.

In other features, the control module is configured to receive a battery charge status signal from the vehicle control module when the charging plug is connected to the charging port of the vehicle, and transmit a disconnection request signal to the vehicle control module or the user device in response to the received battery charge status signal, thereby prompting a user to disconnect the charging plug from the charging port of the vehicle.

In other features, the control module is configured to receive a confirmation disconnection signal from the vehicle control module or the user device based on user input, and control the mobile charging apparatus to move away from the vehicle in response to the confirmation disconnection signal.

In other features, the control module is configured to receive a battery charge status signal from the vehicle control module when the charging plug is connected to the charging port of the vehicle and control the mobile charging apparatus to disconnect the charging plug from the charging port in response to the received battery charge status signal.

In other features, the control module is configured to control movement of the mobile charging apparatus based on user input received from the vehicle control module or the user device.

A method of controlling a mobile charging apparatus is disclosed. The mobile charging apparatus includes a charging plug configured to connect to a charging port of a vehicle for charging a battery in the vehicle. The method includes receiving a charging request signal from a vehicle control module of the vehicle or a user device, in response to receiving the charging request signal, determining a location of the charging port of the vehicle, and controlling the mobile charging apparatus to move adjacent to the charging port of the vehicle based on the determined location of the charging port.

In other features, the mobile charging apparatus includes a movable arm connected to the charging plug, the movable arm includes at least one actuator, and the method further includes controlling the at least one actuator to align the charging plug with the charging port of the vehicle.

In other features, the method further includes receiving a signal from a sensor positioned adjacent to the charging plug, the signal indicative of a user input applied to the charging plug when a user moves the charging plug, and controlling the at least one actuator to move the charging plug based on the received signal.

In other features, determining the location of the charging port of the vehicle includes receiving vehicle data from the vehicle control module or the user device and determining the location of the charging port based on the vehicle data.

In other features, determining the location of the charging port of the vehicle includes receiving a signal from at least one sensor indicative of a detected location of the charging port and determining the location of the charging port based on the received signal.

In other features, the method further includes receiving a confirmation disconnection signal from the vehicle control module or the user device based on user input and controlling the mobile charging apparatus to move away from the vehicle in response to the confirmation disconnection signal.

In other features, the method further includes receiving a battery charge status signal from the vehicle control module of the vehicle when the charging plug is connected to the charging port of the vehicle and controlling the mobile charging apparatus to disconnect the charging plug from the charging port in response to the received battery charge status signal.

A charging system includes a mobile charging apparatus and a control module in communication with the mobile charging apparatus. The mobile charging apparatus includes a movable arm and a charging plug connected to the movable arm. The movable arm includes at least one actuator. The charging plug is configured to connect to a charging port of a vehicle for charging a battery in the vehicle. The control module is configured to receive vehicle data from a vehicle control module of the vehicle, determine a location of the charging port of the vehicle based on the vehicle data, control the mobile charging apparatus to move adjacent to the charging port of the vehicle based on the determined location of the charging port, and control the at least one actuator to align the charging plug with the charging port of the vehicle.

In other features, the movable arm includes a sensor positioned adjacent to the charging plug, the sensor is configured to detect a user input applied to the charging plug when a user moves the charging plug, and the control module is configured to receive a signal from the sensor indicative of the user input and control the at least one actuator to move the charging plug based on the received signal.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle charging system including a mobile charging apparatus according to the present disclosure;

FIG. 2 is an isometric view of an example vehicle charging system including a charging apparatus movable on tracks according to the present disclosure;

FIG. 3 is a side view of the vehicle charging system of FIG. 2 according to the present disclosure;

FIG. 4 is a side view of an example vehicle charging system including a mobile charging apparatus according to the present disclosure;

FIG. 5 is a top view of the vehicle charging system of FIG. 4 according to the present disclosure;

FIG. 6 is a side view of the vehicle charging system of FIG. 4 with the charging apparatus moved adjacent to a vehicle, according to the present disclosure;

FIG. 7 is a functional block diagram of an example movable arm to assist users in moving a charging plug according to the present disclosure; and

FIG. 8 is a flowchart of an example control process for controlling a mobile charging apparatus according to the present disclosure.

In the drawings, reference numbers may be reused to identify similar and/or identical elements.

### DETAILED DESCRIPTION

Electric vehicle charging apparatuses typically include a plug electrically connected to a power source via a cable. Individuals are tasked with inserting the plug into a charging port of an electric vehicle. This is accomplished by physical actions taken by the individuals, such as grasping and pulling the cable towards the electric vehicle, aligning the plug with the charging port, and then forcing the plug into the charging port. Such physical actions are often difficult, particularly for individuals with disabilities. For example, some individuals, such as individuals with dexterity issues and/or individuals who use assistive mobility devices (such as wheelchairs, walkers, canes, etc.), may have difficulties moving the cable due to its weight and/or reaching the cable.

Systems and methods according to the present disclosure include solutions for controlling movement of mobile charging apparatuses and/or components of the apparatuses. For example, a charging system may include a mobile charging apparatus with a charging plug for connecting to a charging port of a vehicle and a control module. In such examples, the control module may receive a charging request signal from a vehicle control module of the vehicle or a user device, determine a location of the charging port of the vehicle, and then control the mobile charging apparatus to move adjacent to the charging port of the vehicle based on the determined location of the charging port. In this manner, the charging plug of the mobile charging apparatus may be located near and aligned with the charging port of electric vehicle with little (and sometimes no) physical actions required by individuals. As such, through the controlled movement of mobile charging apparatuses and/or components of the apparatuses, individuals (e.g., individuals with disabilities that affect their mobility, their capability to reach and handle heavy cables, etc.) may be assisted in charging electric vehicles.

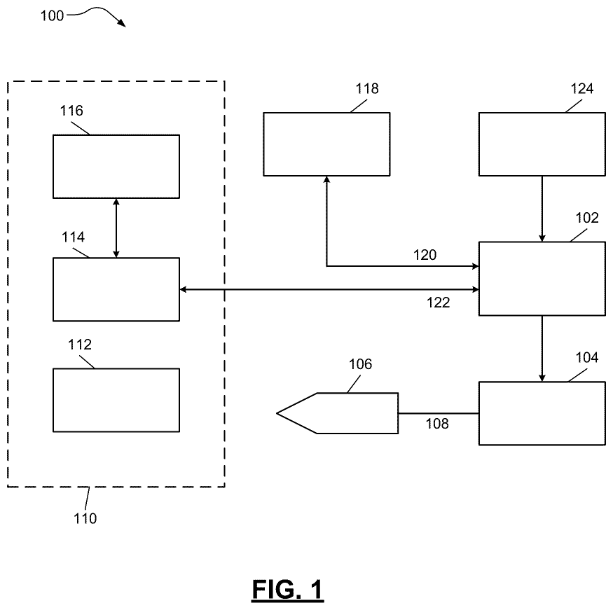

Referring now to FIG. 1, a functional block diagram of an example charging system 100 is presented. The charging system 100 may be for any suitable electric vehicle, such as a pure electric vehicle, a plug-in hybrid electric vehicle, etc.

As shown in FIG. 1, the charging system 100 generally includes a charging apparatus control module 102 and a mobile charging apparatus 104 in communication with the control module 102. In the example of FIG. 1, the mobile charging apparatus 104 includes a charging plug 106 and a cable 108 electrically connecting the charging plug 106 to a power source. In various embodiments, the power source may be located within the charging apparatus 104 and/or connected externally to the charging apparatus 104.

As shown in FIG. 1, the charging system 100 may further include one or more charging apparatus sensors 124 in communication with the charging apparatus control module 102. For example, data may be shared between the sensors 124 and the control module 102 via one or more signals. In such examples, the charging apparatus sensors 124 may include one or more cameras (e.g., motion actuated cameras), radar sensors, RFID readers, registered license plate readers and/or any other suitable detection modules. For example, the sensors 124 may detect a presence of a vehicle 110 and/or another vehicle located in a charging spot associated with the charging system 100. Additionally, the sensors 124 may detect a location of a charging port 112 on the vehicle 110.

The charging plug 106 connects with a charging port of a vehicle for charging a battery in the vehicle, such as the charging port 112 of the vehicle 110 as shown in FIG. 1. For example, the vehicle 110 may include a movable cover positioned adjacent to the charging port 112. Once the cover is moved open, the charging port 112 of the vehicle 110 may be accessible for receiving the charging plug 106.

The cover may be moved in various manners. For example, the cover may be manually manipulated to cause the cover to move (e.g., pivot, slide, etc.) away from the charging port. For example, a user (e.g., a driver, etc.) may push on the cover to release the cover from a mechanical fastener. In other examples, the user may release the cover by selecting a user input in the vehicle to cause the cover to move away from the charging port. In still other embodiments, the cover may be controlled to move into an open position. For example, a vehicle control module 114 in the vehicle 110 may detect the position of the cover (e.g., open) and/or the control module 102 may detect the position of the cover (e.g., open) via the sensors 124. In such examples, either control module may notify the user via a user interface of a display module 116 in the vehicle 110 and/or a user device 118. In other examples, the vehicle control module 114 may automatically open the cover in response to either control module detecting that the cover is closed and/or the charging apparatus 104 may be controlled (e.g., via user input, etc.) to open the cover.

In various embodiments, the charging apparatus control module 102 may communicate with various other modules. For example, and as shown in FIG. 1, the control module 102 may communicate with the user device 118 and/or the vehicle control module 114 of the vehicle 110. In such examples, the user device 118 may be any suitable device, such as a phone, a tablet, etc. Such communication between the control module 102 and the user device 118 and/or the vehicle control module 114 may be established through a wireless connection and/or a wired connection. For example, the vehicle 110 may be equipped with an over-the-air communication system, such as a vehicle communication system, infotainment, etc. Regardless of the type of connection, data may be shared between the control module 102 and the user device 118 via one or more signals 120, and between the control module 102 and the vehicle control module 114 via one or more signals 122.

In the example of FIG. 1, the vehicle 110 may be located in a charging spot associated with the charging system 100. In such examples, the vehicle 110 may be driven (e.g., manually by a driver, autonomous, etc.) into the charging spot. Once the vehicle 110 is sufficiently near to the charging system 100 and/or in the charging spot, the vehicle control module 114 may communicate with the charging apparatus control module 102. For example, the vehicle control module 114 may be a component in a vehicle system that controls, communicates, shares parameters, etc. with other sensors and/or modules in the vehicle 110 via a network, such as a controller area network (CAN). In such examples, the vehicle sensors may include, for example, a location sensor (e.g., a RFID sensor positioned near the charging port 112, a camera, etc.). Various parameters may be made available by a given module (e.g., the vehicle control module 114, etc.) to other modules via the network, such as the display module 116 in the vehicle 110.

For instance, the vehicle control module 114 may provide data to the display module 116 and receive data (e.g., user input) from the display module 116. In such examples, the display module 116 may include a user interface display showing a camera view, user selectable options, etc. based on data received from the vehicle control module 114. Such data may be received from one or more sensors (e.g., cameras, etc.) of the vehicle 110 and/or the one or more sensors 124. The display module 116 may also transmit data to the vehicle control module 114 based on user input provided via the user interface display. Such received user input data may then be passed to the charging apparatus control module 102 as further explained below.

With continued reference to FIG. 1, the charging apparatus control module 102 may control the mobile charging apparatus 104 to move the apparatus 104 near the charging port 112 on the vehicle and/or align the charging plug 106 with the charging port 112. For example, once the vehicle 110 or the user device 118 is sufficiently near to the charging system 100 and/or in the charging spot, the vehicle control module 114 or the device 118 may establish a data transfer connection with the control module 102 through conventional pairing and/or connection steps. This effectively syncs the vehicle control module 114 and/or the user device 118 with the control module 102.

Once synced, the control module 102 may optionally receive vehicle data from the vehicle control module 114 and/or the user device 118. For example, the control module 102 may receive a vehicle make, a vehicle model, a vehicle year, a battery charging status, vehicle settings, a vehicle location, a charging port location, etc. In some examples, the control module 102 may receive a verification indicating the vehicle 110 is in park and turned off, a starting mechanism is disabled, etc. In other examples, the control module 102 may send to the vehicle control module 114 a disable signal (e.g., one of the signals 122) to disable the vehicle start mechanism, a shifting (e.g., from park to drive or reverse, etc.) mechanism, etc.

Additionally, the control module 102 may receive a charging request signal from the vehicle control module 114 and/or the user device 118. In such examples, the control module 102 may receive the charging request signal at the same time, before or after receiving the optional vehicle data. In various embodiments, the vehicle control module 114 and/or the user device 118 may generate and transmit the charging request signal to the control module 102 based on the user selecting an input on the display module 116, in the vehicle 110, on the user device 118, etc.

Then, the control module 102 may determine a location of the charging port 112 of the vehicle 110 in response to receiving the charging request signal. For example, the control module 102 may determine the charging port location based on the received vehicle data. For instance, the vehicle data may include the charging port location (e.g., rear driver side, front passenger side, rear-end, etc.). In other examples, the vehicle data may include the vehicle model or a particular vehicle identification number (VIN). In such examples, the control module 102 may determine the charging port location based on the vehicle model, the VIN, etc.

Additionally and/or alternatively, the control module 102 may determine the location of the charging port 112 based on sensor data from the one or more charging apparatus sensors 124. For example, and explained above, a camera or another suitable detection module may detect the location of the charging port 112 on the vehicle 110, and then transmit a signal to the control module 102. The control module 102 can then determine the charging port location based on the received signal.

In various embodiments, the control module 102 may optionally generate and transmit a confirmation request signal to the vehicle control module 114 and/or the user device 118 to verify the determined location of the charging port 112. For example, the confirmation request signal may include the determined location of the charging port 112. Once received, the user may be prompted to confirm the determined location through, for example, a user interface on the display module 116 and/or the user device 118. In other examples, the determined location may be incorrect. In such examples, the user may use the user interface on the display module 116 and/or the user device 118 to specify a set location of the charging port 112. The vehicle control module 114 and/or the user device 118 may then transmit the set location to the control module 102.

With continued reference to FIG. 1, the control module 102 may then control the mobile charging apparatus 104 to move adjacent to the charging port 112 of the vehicle 110 based on the determined location of the charging port 112. For example, the control module 102 may translate the charging port location to a GPS coordinate, and then control the charging apparatus 104 to move towards the charging port 112 (e.g., to a target position a defined distance away from the charging port 112). In such examples, the charging apparatus 104 may move along one or more tracks positioned on the ground or above the ground (e.g., above the vehicle 110, etc.). In some examples, the charging apparatus 104 may include wheels and a motor to drive the charging apparatus 104 towards the charging port 112.

Additionally and/or alternatively, movement of the charging apparatus 104 may be controlled in part based on user input received from the vehicle control module 114 and/or the user device 118. For example, a user interface on the display module 116 and/or the user device 118 may include one or more controls (e.g., a joystick, arrows, etc.). When selected by the user, the vehicle control module 114 and/or the user device 118 may send signals to the control module 102 for controlling the movement of the charging apparatus 104. Such control may be employed to initially move the charging apparatus 104, to fine tune placement of the charging apparatus 104 near the charging port 112, etc.

In some examples, vehicle sensors and/or the sensors 124 may provide a visual representation to assist the user in controlling the movement of the charging apparatus 104. For example, the display module 116 may present a view of a camera (or another suitable sensor) positioned near the charging port 112 (e.g., directed towards the charging apparatus 104) and/or a camera positioned near the charging apparatus 104 (e.g., directed towards the vehicle 110).

Once the charging apparatus 104 is positioned near the charging port 112 of the vehicle 110, the charging plug 106 may be connected to the charging port 112. At this point, the charging apparatus 104 may begin charging the battery in the vehicle 110 via the power source.

The charging plug 106 may be connected to the charging port 112 in various different manners. For example, after the charging port cover is moved away from the charging port 112 (as explained above), the user may manually grasp the charging plug 106 and/or the cable 108 and insert the charging plug 106 into the charging port 112. Such movement of the charging plug 106 may be based on user manipulation or with assistance. For example, the control module 102 may receive a feedback signal from one or more sensors positioned on the charging plug 106 indicative of the user input (e.g., a torque, a force, etc. applied to the charging plug 106), and then control one or more actuators to assist in moving the charging plug 106. In other examples, the charging plug 106 may be controlled by the control module 102 in a similar manner as the charging apparatus 104, such as based on the determined location of the charging port 112, user input received from the vehicle control module 114 and/or the user device 118, etc.

In various embodiments, the control module 102 may optionally receive a battery charge status signal from the vehicle control module 114 when the charging plug 106 is connected to the charging port 112 of the vehicle 110. For example, the battery charge status signal may indicate whether the battery in the vehicle 110 is charged to a desired level (e.g., fully charged, a defined percentage, etc.) as set by the user.

Then, the control module 102 may begin steps to stop charging the battery and/or move the mobile charging apparatus 104 away from the vehicle 110 once the battery is charge to the desired level. For example, the control module 102 may transmit a disconnection request signal to the vehicle control module 114 and/or the user device 118 in response to the received battery charge status signal. In such examples, the user may then be prompted via, for example, a user interface on the display module 116 and/or the user device 118 to manually disconnect the charging plug 106 from the charging port 112.

Additionally, the control module 102 may receive a confirmation disconnection signal from the vehicle control module 114 and/or the user device 118 based on user input, and then control the mobile charging apparatus 104 to move away from the vehicle 110 in response to the confirmation disconnection signal. For example, once the charging plug 106 is disconnected from the charging port 112, the user may select an input on the display module 116 and/or the user device 118. In response, the confirmation disconnection signal may be generated and provided to the control module 102. Once received, the control module 102 may control the mobile charging apparatus 104 to move away from the vehicle 110 and possibly return to a default position. In various embodiments, the control module 102 may control movement of the charging apparatus 104 based on user input received from the vehicle control module 114 and/or the user device 118 (e.g., as explained above), based on a defined location (e.g., a default GPS coordinate), etc.

In other examples, the control module 102 may control the mobile charging apparatus 104 to disconnect the charging plug 106 from the charging port 112 in response to the received battery charge status signal. For example, the control module 102 may control the charging apparatus 104 and/or the cable 108 (e.g., via one or more actuators) to pull away from the vehicle 110, thereby causing the charging plug 106 to disconnect from the charging port 112. In such examples, the charging apparatus 104 may be controlled to return to a default position as explained above.

In various embodiments, the cover may be moved to conceal the charging port 112 of the vehicle 110 after the charging plug 106 is disconnected from the charging port 112. For example, the cover may be manually manipulated by the user and/or controlled to move after the charging plug 106 is disconnected. In such examples, the cover may be controlled based on user input provided by the user. For example, the vehicle control module 114 may detect the position of the cover (e.g., open) and/or the control module 102 may detect the position of the cover (e.g., open) via the sensors 124. In such examples, either control module may notify the user via a user interface of the display module 116 and/or the user device 118. In other examples, the vehicle control module 114 may automatically close the cover in response to either control module detecting that the cover is open and/or the charging apparatus 104 may be controlled (e.g., via user input, etc.) to close the cover.

Additionally, in some examples, the control module 102 may disconnect with the vehicle control module 114 once the charging apparatus 104 has moved away from the vehicle 110. In such examples, the vehicle start mechanism, the shifting (e.g., from park to drive or reverse, etc.) mechanism, etc. may be reenabled by, for example, the vehicle control module 114, thereby allowing the driver to move the vehicle 110 as desired.

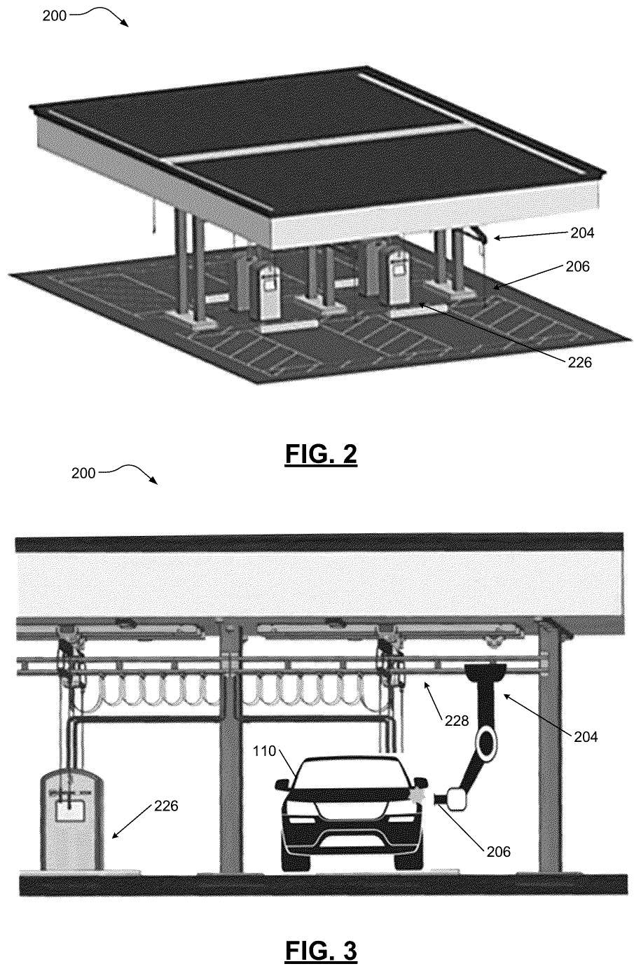

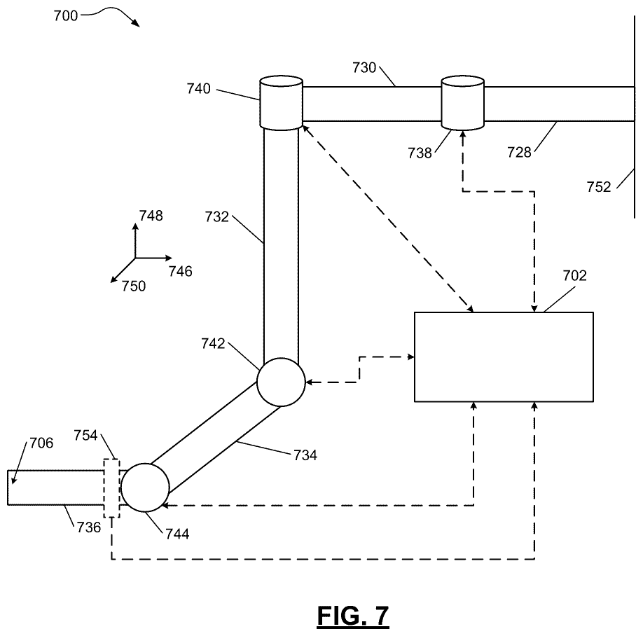

As explained above, the charging apparatus 104 may be moved between different locations. In such examples, the charging apparatus 104 may include wheels that travel along one or more tracks positioned on the ground, in the air (e.g., coupled to a canopy, etc.). In other examples, the wheels may move the charging apparatus 104 without a track system. FIGS. 2-6 depict various embodiments of vehicle charging systems 200, 400 in which charging apparatuses may be moved between different locations (e.g., towards a vehicle, away from a vehicle, etc.) as explained herein.

For example, the vehicle charging system 200 of FIGS. 2-3 includes a charging apparatus 204 having a charging plug 206 connected to a power source 226. In such examples, the charging apparatus 204 and the charging plug 206 may function in a similar as the charging apparatus 104 and the charging plug 106 as explained above. For example, in the example of FIGS. 2-3, the charging apparatus 204 may be controlled to move adjacent to a charging port of the vehicle 110 located in a nearby parking spot. In such examples, the charging apparatus 204 is moved along a track system 228 coupled to a canopy of the system 200.

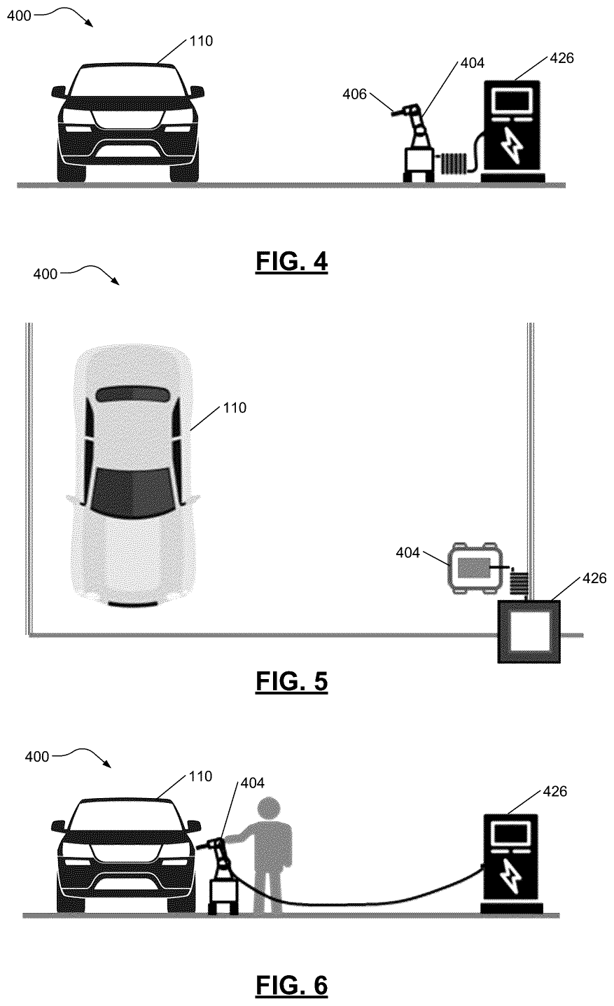

In other examples, the charging apparatus moves along the ground. For example, the vehicle charging system 400 of FIGS. 4-6 includes a charging apparatus 404 including a charging plug 406 connected to a power source 426. In such examples, the charging apparatus 404 and the charging plug 406 may function in a similar as the charging apparatus 104 and the charging plug 106 as explained above. For example, in the example of FIGS. 4-6, the charging apparatus 404 may be controlled to move adjacent to a charging port of the vehicle 110. In such examples, the charging apparatus 404 is moved along the ground.

Although the vehicle charging systems 100, 200, 400 of FIGS. 1-6 are described herein as including one charging apparatus, it should be appreciated that any one of the vehicle charging systems 100, 200, 400 may include multiple mobile charging apparatuses each functioning in a similar manner as the charging apparatus 104 described herein.

In various embodiments, any one of the charging systems herein may include a movable, robotic arm for assisting users to move a charging plug and align the charging plug with a charging port of a vehicle. By employing the movable, robotic arm, the amount of force required by users to move a charging plug and/or cable may be reduced as compared to manually moving the charging plug and/or cable.

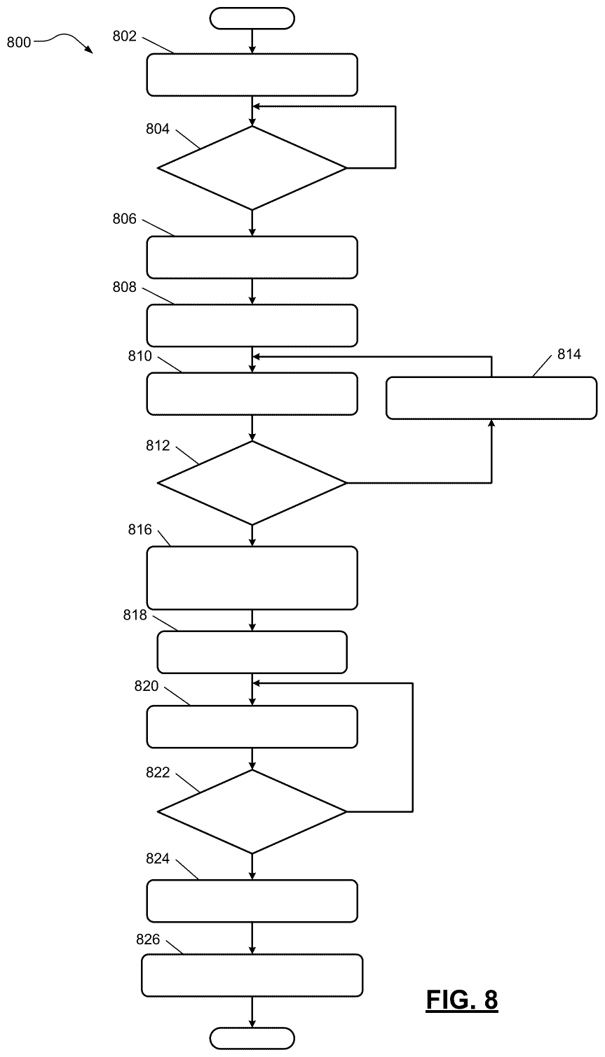

For example, FIG. 7 depicts a movable, robotic arm 700 employable with any one of the charging systems 100, 200, 400. The movable arm 700 generally includes multiple arm segments 728, 730, 732, 734, 736, multiple actuators (e.g., motors, etc.) 738, 740, 742, 744, and an optional sensor 754. In the example of FIG. 7, each actuator 738, 740, 742, 744 is connected between two adjacent arm segments 728, 730, 732, 734, 736. Additionally, the arm segment 736 includes a charging plug 706 that functions in a similar manner as the charging plug 106 as explained above. The arm segment 728 is connected to a portion (e.g., a wall, etc.) 752 of a charging apparatus, such as one of the charging apparatuses 104, 204, 404 of FIGS. 1-6. While the movable arm 700 of FIG. 7 is shown as including five arm segments 728, 730, 732, 734, 736 and four actuators 738, 740, 742, 744, it should be appreciated that the movable arm 700 may include more or less arm segments and/or actuators as desired.

In the example of FIG. 7, the actuators 738, 740, 742, 744 may be controlled to move the charging plug 706 as desired. For example, the actuators 738, 740, 742, 744 may function as controllable joints to move their associated arm segments 728, 730, 732, 734, 736, thereby causing movement of the charging plug 706 in three-dimensional space. Specifically, the actuators 738, 740 may be controlled to cause movement of the charging plug 706 in the X-Y plane (with the X-axis shown by arrow 750 and the y-axis shown by arrow 746 in FIG. 7), and the actuators 742, 744 may be controlled to cause movement of the charging plug 706 along the Z-axis (shown by arrow 748) as well as a pitch angle of the plug 706. In various embodiments, the actuators 742, 744 may cause a change (e.g., a slight change, etc.) in the movement of the plug 706 in the X-Y plane as a dependent motion. In this manner, any one or a combination of the actuators 738, 740, 742, 744 may be controlled to align the charging plug 706 with a charging port of a vehicle.

In various embodiments, a control module 702 may be employed to control the actuators 738, 740, 742, 744. In such examples, the control module 702 may be a charging apparatus control module (e.g., the control module 102 of FIG. 1) that controls the charging apparatus along with the actuators 738, 740, 742, 744. Alternatively, the control module 702 may be in communication with a charging apparatus control module. In such examples, the actuators 738, 740, 742, 744 may be controlled in a similar manner as the charging apparatus, such as based on a determined location of the charging port, user input received from a vehicle control module and/or a user device 118, etc. as explained above.

Additionally and/or alternatively, the control module 702 may control the actuators 738, 740, 742, 744 based on the sensor 754 positioned adjacent to the charging plug 706. For example, the sensor 754 may detect a user input applied to the charging plug 706 when the user moves the charging plug 706. For instance, when the user grabs and pulls the charging plug 706, the sensor 754 may detect the user's intention by measuring the user input (e.g., a force and/or a torque) applied to the charging plug 706 and transmitting a signal to the control module 702 indicative of the user input. In this manner, the sensor 754 may detect and measure the applied force and/or torque when the user pulls and/or twists the charging plug 706.

The control module 702 may then receive the signal and process data therein to determine the user's intention (e.g., moving the charging plug 706 downward, upward, to the right, to the left, etc.) based on the applied force and/or torque. Then, the control module 702 can control any one or more of the actuators 738, 740, 742, 744 to move the charging plug 706 based on the received signal. For example, the control module 702 may transmit signals to servos for driving the actuators 738, 740, 742, 744.

In various embodiments, the control module 702 may control the actuators 738, 740, 742, 744 based on feedback from any one or more of the actuators. For instance, in some embodiments, encoders associated with the actuators 738, 740, 742, 744 may provide data to the control module 702 indicating movements taken by the actuators 738, 740, 742, 744. The control module 702 may then control any one or more of the actuators based on the received data.

FIG. 8 illustrates an example control process 800 employable by the control module 102 of FIG. 1 for controlling the mobile charging apparatus 104 and/or the charging plug 106. Although the example control process 800 is described in relation to the charging system 100 of FIG. 1 including the control module 102, the control process 800 may be employable by any suitable system. In the example of FIG. 8, the control process 800 may start when the system 100 is powered-on, when one or more of the sensors 124 detect a presence of a vehicle (e.g., the vehicle 110), and/or at another suitable time.

As shown in FIG. 8, control begins at 802 where the control module 102 syncs with the vehicle. For example, once the vehicle is sufficiently near to the charging system 100 and/or in a charging spot, the control module 102 and a control module in the vehicle and/or a user device may establish a data transfer connection. This allows the control module 102 and the vehicle control module and/or the user device to communicate data with each other. For example, once synced, the control module 102 may confirm a vehicle status by receiving a verification indicating the vehicle is in park and turned off, a starting mechanism is disabled, etc. Additionally, in some examples, the control module 102 disable the vehicle start mechanism, a shifting (e.g., from park to drive or reverse, etc.) mechanism, etc. once the control module 102 is synced with the vehicle control module. In various embodiments, the syncing of the control module 102 and the vehicle control module and/or the user device may be performed through conventional pairing and/or connection steps. Control then proceeds to 804.

At 804, the control module 102 determines if a charging request signal is received. In such examples, the charging request signal may be received from the vehicle (e.g., the vehicle control module 114 of the vehicle 110) and/or the user device (e.g., the user device 118, etc.). If the charging request signal is received, control proceeds to 806. Otherwise, control may return to 804 as shown in FIG. 8. In other examples, control may disconnect or unsync the control module 102 from the vehicle control module and/or the user device if a charging request signal is not received within a defined period of time, and then return to 802 or end if desired.

At 806, the control module 102 optionally receives vehicle data from the vehicle control module and/or sensors associated with the control module 102. For example, the control module 102 may receive a vehicle make, a vehicle model, a vehicle year, vehicle settings, a vehicle location, a charging port location, etc. from the vehicle control module. Additionally and/or alternatively, the control module 102 may receive data from the charging apparatus sensors 124 indicating a charging port location of the vehicle. Control then proceeds to 808.

At 808, the control module 102 determines a location of the charging port of the vehicle. For example, the control module 102 may determine the charging port location based on the received vehicle data and/or the sensor data. For instance, the vehicle data may include the charging port location (e.g., rear driver side, front passenger side, rear-end, etc.). In other examples, the control module 102 may determine the charging port location based on a vehicle model or a particular vehicle identification number (VIN) received from the vehicle control module. In still other embodiments, the control module 102 may determine the charging port location based on data provided by a camera (e.g., one of the charging apparatus sensors 124) external to the vehicle. Control then proceeds to 810.

At 810, the control module 102 optionally transmits a location confirmation request signal to the vehicle control module and/or the user device to verify the determined location of the charging port. The user may then be prompted (e.g., on a user interface) to respond to the request by either confirming the location or indicating the location is incorrect. In response, the control module 102 may receive a response message from the vehicle control module and/or the user device. Control may then proceed to 812.

At 812, the control module 102 determines whether the determined charging port location is correct based on, for example, the response message from the vehicle control module and/or the user device. If the determined charging port location is correct (e.g., as confirmed by the user), control proceeds to 816. If, however, the determined charging port location is incorrect (e.g., as indicated by the user), control proceeds to 814.

At 814, the control module 102 optionally transmits a request for a set location of the charging port. For example, the control module 102 may send the request to the vehicle control module and/or the user device. The user may then be prompted (e.g., on a user interface) to respond to the request by specifying the charging port location on the vehicle (e.g., rear driver side, front passenger side, rear-end, etc.). In response, the control module 102 may receive a response message from the vehicle control module and/or the user device including the set location of the charging port. Control may then return to 810 as shown in FIG. 8 or proceed to 816 if desired.

At 816, the control module 102 controls the mobile charging apparatus 104 to move towards the charging port. For example, the control module 102 may control the charging apparatus 104 to move adjacent to the charging port of the vehicle based on the determined location of the charging port, as explained above. In such examples, the charging apparatus 104 may be controlled to move to a target position a defined distance away from the charging port. In some examples, movement of the charging apparatus 104 may be controlled in part based on user input received from the vehicle control module and/or the user device, as explained herein. Control may then proceed to 818.

At 818, the control module 102 connects and/or assists in connecting the charging plug 106 to the charging port of the vehicle. For example, the charging plug 106 may be controlled by the control module 102 to move towards the charging plug 106 and forced into the charging port, based on the determined location of the charging port and/or user input received from the vehicle control module and/or the user device, as explained herein. In other examples, the user may manually grasp and insert the charging plug into the charging port. In such examples, the control module 102 may detect user inputs (e.g., a force, a torque, etc.) applied to the charging port by the user via one or more sensors on the charging plug, predict the user's intention based on the user inputs, and then control movement of the charging plug to assist the user in aligning and connecting the charging plug 106 to the charging port of the vehicle, as explained herein. Control then proceeds to 820 and 822.

At 820, the control module 102 controls a power supply to charge a battery in the vehicle. Then, at 822, the control module 102 determines whether the battery in the vehicle is charged to a desired level (e.g., fully charged, a defined percentage, etc.) as set by the user. In various embodiments, the desired charge level may be provided to the control module 102 when the control module 102 receives vehicle data. If the battery in the vehicle is charged to the desired level, control proceeds to 824. Otherwise, control returns to 820.

At 824, the control module 102 disconnects and/or assists in disconnecting the charging plug 106 from the charging port of the vehicle. For example, the charging plug 106 may be controlled by the control module 102 to move away from the charging plug 106 based on the determined location of the charging port and/or user input received from the vehicle control module and/or the user device, as explained herein. In other examples, the control module 102 may detect user inputs (e.g., a force, a torque, etc.) applied to the charging port by the user as explained above, and then control movement of the charging plug to assist the user in disconnecting the charging plug 106 from the charging port of the vehicle, as explained herein. Control then proceeds to 826.

At 826, the control module 102 controls the mobile charging apparatus 104 to move away from the charging port and the vehicle. For example, the control module 102 may control the charging apparatus 104 to return to a default position or location once the charging plug 106 is disconnected. Control may then end.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java@, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A charging system comprising:
a mobile charging apparatus including a charging plug configured to connect to a charging port of a vehicle for charging a battery in the vehicle; and
a control module in communication with the mobile charging apparatus, the control module configured to:
receive a charging request signal from a vehicle control module of the vehicle or a user device;
in response to receiving the charging request signal, determine a location of the charging port of the vehicle; and
control the mobile charging apparatus to move adjacent to the charging port of the vehicle based on the determined location of the charging port.

2. The charging system of claim 1, wherein:
the mobile charging apparatus includes a movable arm connected to the charging plug;
the movable arm includes at least one actuator; and
the control module is configured to control the at least one actuator to align the charging plug with the charging port of the vehicle.

3. The charging system of claim 2, wherein:
the movable arm includes a sensor positioned adjacent to the charging plug;
the sensor is configured to detect a user input applied to the charging plug when a user moves the charging plug; and
the control module is configured to receive a signal from the sensor indicative of the user input and control the at least one actuator to move the charging plug based on the received signal.

4. The charging system of claim 3, wherein the user input includes at least one of a torque and a force applied to the charging plug.

5. The charging system of claim 1, wherein the control module is configured to:
receive vehicle data from the vehicle control module or the user device; and
determine the location of the charging port of the vehicle based on the vehicle data.

6. The charging system of claim 1, further comprising at least one sensor in communication with the control module, the at least one sensor configured to detect the location of the charging port of the vehicle, wherein the control module is configured to receive a signal from the at least one sensor indicative of the detected location and determine the location of the charging port of the vehicle based on the received signal.

7. The charging system of claim 1, wherein the control module is configured to transmit a confirmation request signal including the determined location of the charging port to the vehicle control module or the user device, thereby prompting a user to confirm the determined location of the charging port.

8. The charging system of claim 1, wherein the control module is configured to:
receive a battery charge status signal from the vehicle control module when the charging plug is connected to the charging port of the vehicle; and
transmit a disconnection request signal to the vehicle control module or the user device in response to the received battery charge status signal, thereby prompting a user to disconnect the charging plug from the charging port of the vehicle.

9. The charging system of claim 8, wherein the control module is configured to:
receive a confirmation disconnection signal from the vehicle control module or the user device based on user input; and
control the mobile charging apparatus to move away from the vehicle in response to the confirmation disconnection signal.

10. The charging system of claim 1, wherein the control module is configured to:
receive a battery charge status signal from the vehicle control module when the charging plug is connected to the charging port of the vehicle; and
control the mobile charging apparatus to disconnect the charging plug from the charging port in response to the received battery charge status signal.

11. The charging system of claim 1, wherein the control module is configured to control movement of the mobile charging apparatus based on user input received from the vehicle control module or the user device.

12. A method of controlling a mobile charging apparatus, the mobile charging apparatus including a charging plug configured to connect to a charging port of a vehicle for charging a battery in the vehicle, the method comprising:
receiving a charging request signal from a vehicle control module of the vehicle or a user device;
in response to receiving the charging request signal, determining a location of the charging port of the vehicle; and
controlling the mobile charging apparatus to move adjacent to the charging port of the vehicle based on the determined location of the charging port.

13. The method of claim 12, wherein:
the mobile charging apparatus includes a movable arm connected to the charging plug;
the movable arm includes at least one actuator; and
the method further comprises controlling the at least one actuator to align the charging plug with the charging port of the vehicle.

14. The method of claim 13, further comprising:
receiving a signal from a sensor positioned adjacent to the charging plug, the signal indicative of a user input applied to the charging plug when a user moves the charging plug; and
controlling the at least one actuator to move the charging plug based on the received signal.

15. The method of claim 12, wherein determining the location of the charging port of the vehicle includes receiving vehicle data from the vehicle control module or the user device and determining the location of the charging port based on the vehicle data.

16. The method of claim 12, wherein determining the location of the charging port of the vehicle includes receiving a signal from at least one sensor indicative of a detected location of the charging port and determining the location of the charging port based on the received signal.

17. The method of claim 12, further comprising:
receiving a confirmation disconnection signal from the vehicle control module or the user device based on user input; and
controlling the mobile charging apparatus to move away from the vehicle in response to the confirmation disconnection signal.

18. The method of claim 12, further comprising:
receiving a battery charge status signal from the vehicle control module of the vehicle when the charging plug is connected to the charging port of the vehicle; and
controlling the mobile charging apparatus to disconnect the charging plug from the charging port in response to the received battery charge status signal.

19. A charging system comprising:
a mobile charging apparatus including a movable arm and a charging plug connected to the movable arm, the movable arm including at least one actuator, the charging plug configured to connect to a charging port of a vehicle for charging a battery in the vehicle; and
a control module in communication with the mobile charging apparatus, the control module configured to:
receive vehicle data from a vehicle control module of the vehicle;
determine a location of the charging port of the vehicle based on the vehicle data;
control the mobile charging apparatus to move adjacent to the charging port of the vehicle based on the determined location of the charging port; and
control the at least one actuator to align the charging plug with the charging port of the vehicle.

20. The charging system of claim 19, wherein:
the movable arm includes a sensor positioned adjacent to the charging plug;
the sensor is configured to detect a user input applied to the charging plug when a user moves the charging plug; and
the control module is configured to receive a signal from the sensor indicative of the user input and control the at least one actuator to move the charging plug based on the received signal.
